(19) United States
(12) Patent Application Publication
(10) Pub. No.: US 2024/0227660 A1
(43) Pub. Date: Jul. 11, 2024

(54) CARGO RETENTION APPARATUS AND SYSTEM

(71) Applicant: Eric Richardson, Goose Creek, SC (US)

(72) Inventor: Eric Richardson, Goose Creek, SC (US)

(21) Appl. No.: 18/541,575

(22) Filed: Dec. 15, 2023

Related U.S. Application Data
(60) Provisional application No. 63/437,624, filed on Jan. 6, 2023.

(51) Int. Cl. B60P 7/08

(52) U.S. Cl. CPC B60P 7/0876; B60P 7/0823

(57) ABSTRACT

A cargo retention system includes a receptacle having an interior and an exterior. The interior of the receptacle is adapted to partially retain cargo. The exterior of the receptacle includes indicia adapted to visually indicate the terminus of the cargo. A plurality of cam-controlled straps are included. Each one of the plurality of cam-controlled straps separately coupled to the exterior of the receptacle, wherein each one of the plurality of cam-controlled straps comprises an elongated strap adjustable and adapted for a variety of lengths via a cam buckle, wherein each one of the plurality of cam-controlled straps is adapted to secure within the bed of a vehicle.

### I. RELATED APPLICATIONS

This application claims the benefit of U.S. Provisional Application No. 63/437,624, filed on Jan. 6, 2023.

### II. FIELD OF THE INVENTION

This application discloses claims and embodiments generally related to a cargo retention apparatus and system, and in particular, an apparatus and system having visual indicia designating the terminus of the cargo retained by the apparatus and system and secured to a vehicle via a plurality of cam-controlled straps.

### III. BACKGROUND OF THE INVENTION

Family and passenger automobiles, those designed mostly for transporting people from one location to another, and in particular cars and trucks are often employed for transporting large, bulky items over short or medium distances. However, most cars and trucks are not designed and not intended for such hauling and transport. Thus, to save on the costs of paying for delivery and/or paying rental fees to obtain transportation more suitable for such materials transport, individual often make-do with the automobiles that they possess.

However, such improvisational use of passenger automobiles increases safety concerns. With oversized material, such as lumber that can measure in exceess of 8 to 12 feet and far exceed the standard length of a pick-up truck bed and/or the interior cargo space of a sports utility vehicle (SUV) or adjustable sedans or hatchbacks, such material extends beyond the support of the bed or base of the vehicle. In addition, the material is often shaped or contoured in a manner that requires some security measure to prevent lateral load shifting and/or longitudinal ejection of the material. By law, material loads that extend beyond the bed of a vehicle must be marked so that other automobile drivers can easily see and perhaps be better prepared for navigating around or near such material load transports.

As a result of such situations and realities, a variety of cargo retention devices, apparatuses, and/or systems have been developed to address such concerns. In particular, numerous attempts have been made to improve cargo retention apparatuses and/or systems. For example, fabric envelopes are very popular forms of controlling and retaining loads in the cargo storage area(s) of vehicles, including the typical elastic-type netting with a plurality of hooks or other attachment means. A wide variety of this type of retention device may be found on popular general retail platforms and specialty retail platforms. Moreover, combinations of fabric envelopes and cargo bags may be utilized for retaining stowable materials or items. For example, MAXXHAUL™ RHINO USA™, and CURT™ each promote and sell variously sized cargo bags that may be used in combination with cargo envelopes of the type described above.

Several cargo retention systems have been published, including U.S. Pat. No. 6,863,482 issued to Lockhart et al. in March 2005. Lockhart et al. describes a cargo retention system comprising a lattice having a plurality fo radially oriented ribs with an overlying mesh web. Two anchoring strap networks connect to the lattice. The system is intended to retain a variety of loads extending outwardly from a vehicle, and includes a storage pouch and safety flag and optional lights to improve visualization and improve safety.

Accordingly, a need exists for an improved cargo retention device and/or system that overcomes the existing problems that are not addressed by presently available devices and systems.

### IV. SUMMARY OF THE INVENTION

In one embodiment, a cargo retention system comprising a receptacle having an interior and an exterior, the exterior of the receptacle having indicia adapted to visually indicate the terminus of the cargo retained therein, a plurality of cam-controlled straps, each one of the plurality of cam-controlled straps separately coupled to the exterior of the receptacle, wherein each one of the plurality of cam-controlled straps comprises an elongated strap adjustable and adapted for a variety of lengths via a cam buckle, wherein each one of the plurality of cam-controlled straps is adapted to secure within the bed of a vehicle.

In another embodiment, a cargo retention system comprising a receptacle having an interior and an exterior, the interior of the receptacle adapted to partially retain cargo the exterior of the receptacle having indicia adapted to visually indicate the terminus of the cargo retained therein, a plurality of cam-controlled straps, each one of the plurality of cam-controlled straps separately coupled to the exterior of the receptacle, wherein each one of the plurality of cam-controlled straps comprises an elongated strap adjustable and adapted for a variety of lengths via a cam buckle, wherein each one of the plurality of cam-controlled straps is adapted to secure within the bed of a vehicle.

In another embodiment, a cargo retention system comprising a receptacle having an interior and an exterior, the interior of the receptacle adapted to partially retain cargo the exterior of the receptacle having indicia adapted to visually indicate the terminus of the cargo retained therein, a plurality of cam-controlled straps, each one of the plurality of cam-controlled straps separately coupled to the exterior of the receptacle, wherein each one of the plurality of cam-controlled straps comprises an elongated strap adjustable and adapted for a variety of lengths via a cam buckle, wherein each one of the plurality of cam-controlled straps is adapted to secure to a hasp affixed within the bed well of a vehicle.

For any of the aforementioned embodiments, the system may further comprise or include the interior of the receptacle that is formed from a single material selected from the group consisting of rigid material, semi-rigid material, returnably resilient material, flexible material, and fluid permeable material. Moreover, the interior receptacle comprises an adjustable form or shape. In particular, the interior receptacle comprises a form selected from the group consisting of cylindrical and orthogonal.

For any of the aforementioned embodiments, the system may further comprise or include the interior of the receptacle is formed from a combination of materials selected from the group consisting of rigid material, semi-rigid material, returnably resilient material, flexible material, and fluid permeable material. Moreover, the interior receptacle comprises an adjustable form or shape. In particular, the interior receptacle comprises a form selected from the group consisting of cylindrical and orthogonal.

For the aforementioned embodiments, the indicia comprises in combination one or more colors, signs, designs, indicators, and alphanumeric symbols.

For the aforementioned embodiments, and alternatively, the indicia comprises in combination one or more tape, fabric, material, paint, coating, and colorant.

### V. BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 is a side perspective view of the cargo retention apparatus and system;

FIG. 2 is a top view of the cargo retention apparatus and system;

FIG. 3 is a perspective view of the cargo retention apparatus and system;

FIG. 4 is a perspective view of the cargo retention system;

FIG. 5 is a rear perspective view of the cargo retention apparatus and system; and

FIG. 6 is a perspective view of the cam straps.

### VI. DETAILED DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

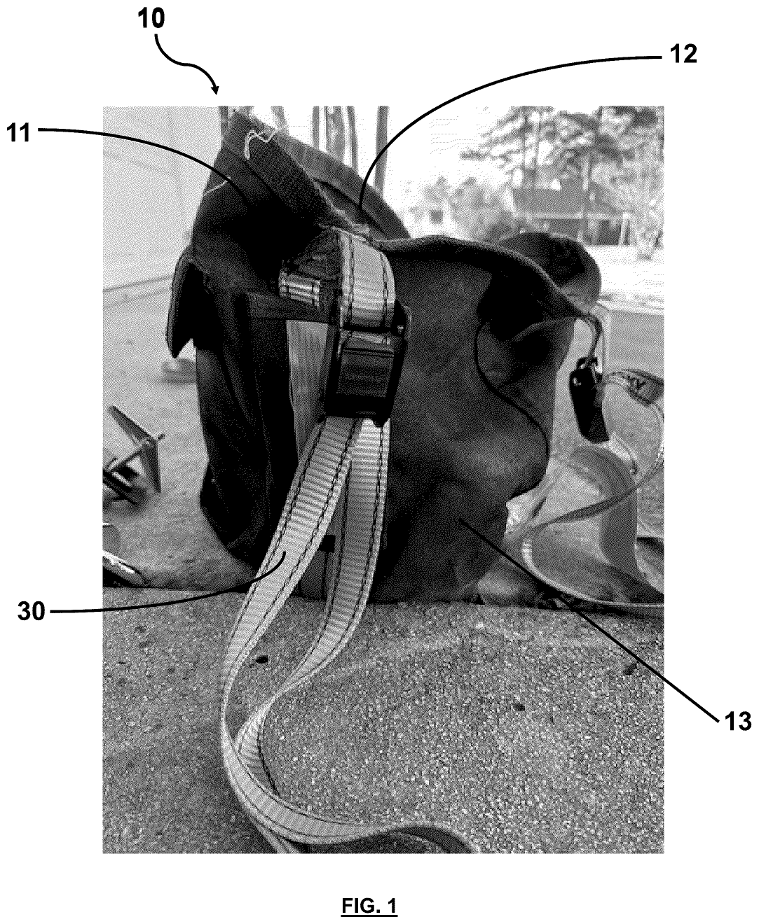

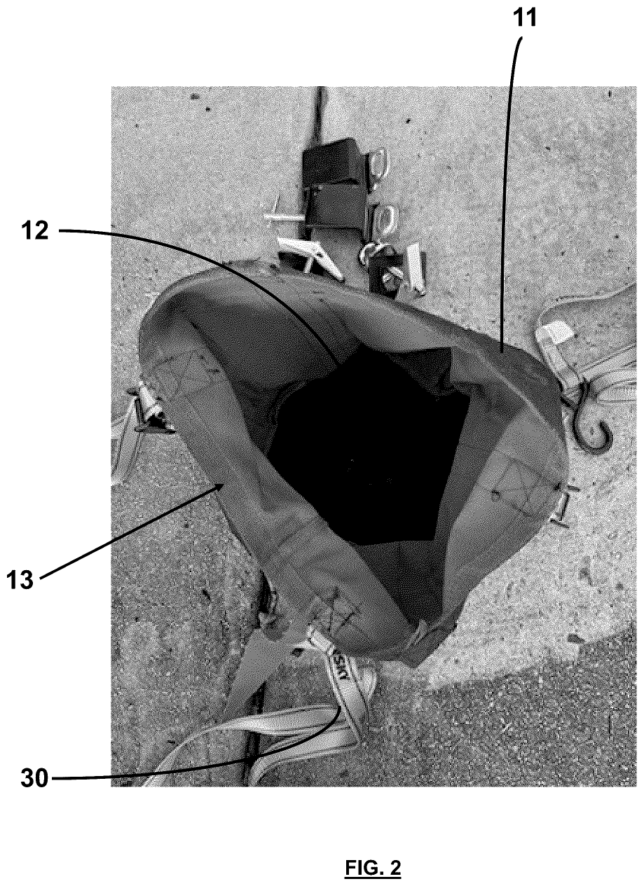

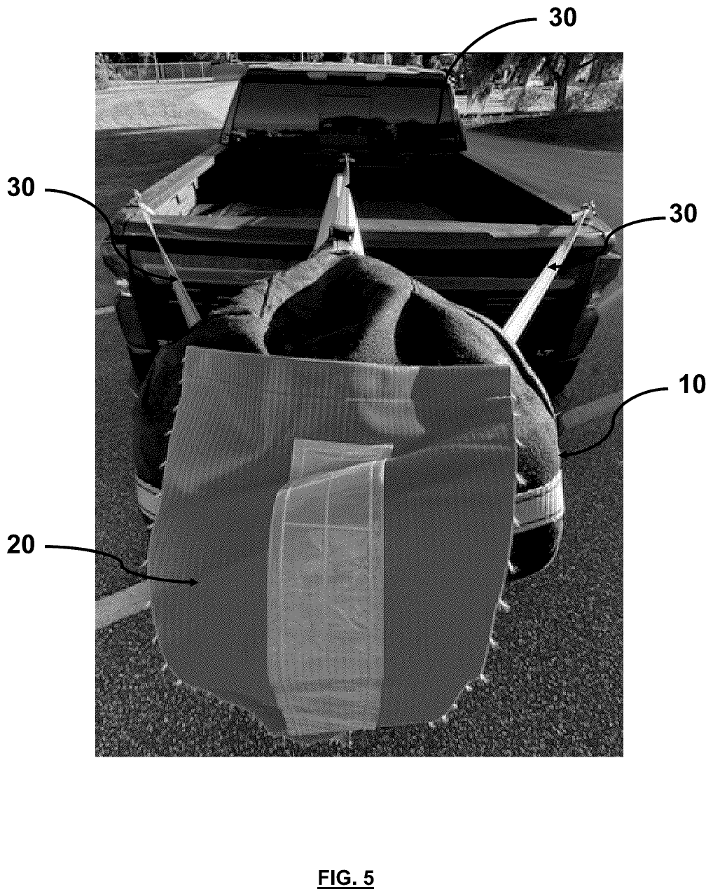

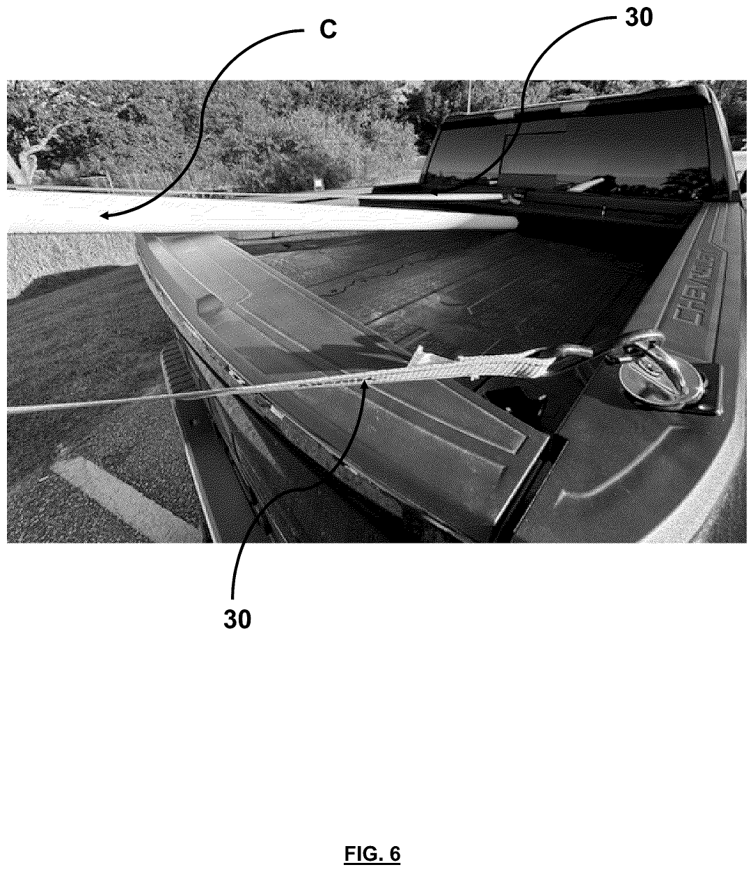

According to at least one embodiment, and consistent with the drawing(s) and illustration(s), a cargo retention apparatus and/or system is generally denoted by reference character 10 as illustrated in FIG. 1 through FIG. 6. The apparatus/system 10 includes a receptacle 13 having an interior 11 and an exterior 12. A plurality of cam-controlled straps 30 are separately coupled to the exterior 12 of the receptacle 13.

The interior 11 of the receptacle 13 is adapted to partially retain cargo (occasionally referenced as “C”). The receptacle 13 may be formed or defined in a variety of ways and from a variety of materials. For example, receptacle 13 may be formed of a single material or of a combination of materials that include rigid, semi-rigid, returnably resilient, flexible, and/or fluid permeable material(s). The material(s) define the interior 11 of the receptacle 13 that may include amorphous/adjustable form, a cylindrical form, an orthogonal form, and/or other similar form(s) that are envisioned

Within the interior 11, cargo may be positioned for retention therein, especially during transportation in the bed of a vehicle. The interior 11 may have a variety of dimensions to accommodate variously sized items constituting cargo. It is not anticipated that the interior 11 of the receptacle 13 must completely envelope or encompass the item or items constituting the cargo; rather, the interior 11 partially houses and retains the item or items before tightening of the straps 30. Partial coverage of the cargo and visual indication that the retained element(s) is/are cargo is sufficient for compliance with various transportation regulations. Accordingly, it is unnecessary that the interior 11 of receptacle 13 completely cover or retain the entirety of the cargo.

The exterior 12 of receptacle 13 includes indicia adapted to visually indicate the terminus of the cargo. The indicia 20 is utilized as a visual safety aid for vehicle traffic following behind the vehicle with the cargo. The indicia 20 may include a variety of options or combinations thereof.

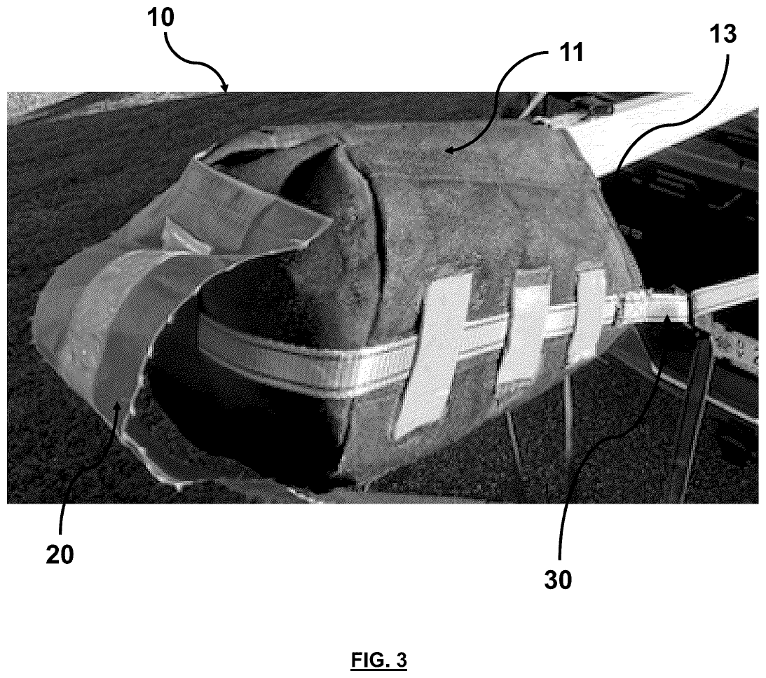

For example, as best illustrated in FIG. 3 through FIG. 5, the indicia 20 may be an applied element that may be added and removed as desired, the indicia 20 having an appropriate color, colors, sign, signs, indicators, or combinations thereof to provide such safety indication to vehicle traffic. In such an example, the applied element may have indicia on one side or alternatively may have indicia on both sides thereof. It is envisioned that the indicia may have a particular form or format on one side and a different form or format on the opposite side. It is also envisioned that the indicia may be substantially similar and/or identical on each side of the applied element. Whether in an applied or attachable form or an integrated element form, the indicia 20 is envisioned as reversible and adapted for performing as a visual safety indicator for vehicle traffic following behind the cargo.

In another example, the indicia 20 may comprise color(s), sign(s), design(s), and/or indicator(s) that form part of or all of the exterior 12 of receptacle 13. Similar to any applied element, such indicia 20 that forms part of or all of the exterior 12 of the receptacle 13 may assume any sign, design, and/or indication that communicates safety information to vehicle traffic following behind the cargo. Such sign(s), design, and/or indication(s) may include words, abbreviations, punctuation, numerals, colors, and/or combinations of such that effectively communicates the appropriate safety condition and orientation of the cargo in the hauling vehicle as is pertinent to the vehicle traffic following the hauling vehicle.

Indicia 20 may be formed from fabric or material, such as reflective tape or fabric of various colors that may be integrated into the existing structure of the exterior 12 of the receptacle 13. Alternatively, the indicia 20 may be formed by paint, coating, colorant, or other similar means, which may be integrated into the formation of the exterior 12 surface(s) of the receptacle 13.

A plurality of cam-controlled straps 30 are included. Each one of the plurality of cam-controlled straps 30 is separately coupled to the exterior of the receptacle 13. Each one of the plurality of cam-controlled straps 30 comprises an elongated strap 31 adjustable and adapted for a variety of lengths via a cam buckle 32. At one terminus of the strap 31 is a hook for securing the receptacle 13 within the bed of the hauling vehicle. Usually, the hook is placed within bed wells and secured to a hasp affixed within the bed well of the vehicle.

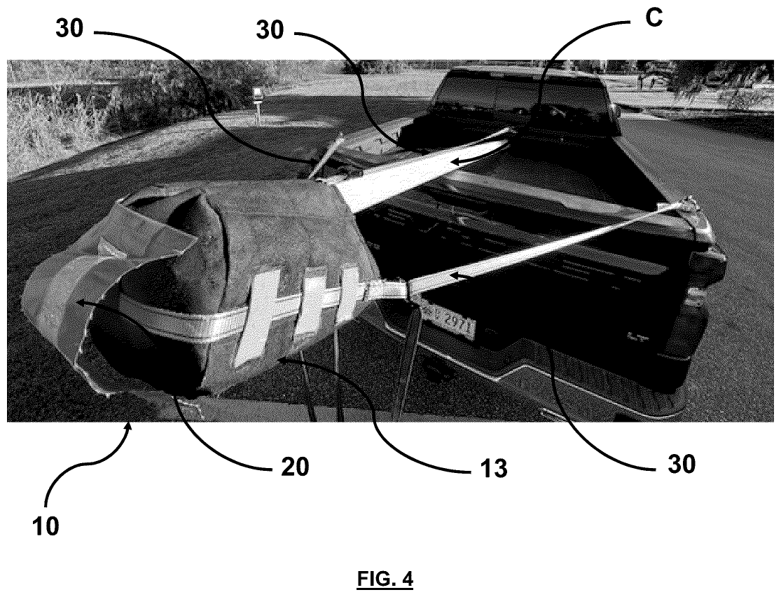

As illustrated in FIG. 4 through FIG. 6, the apparatus/system 10 is depicted as installed within a truck bed. Two of the straps 30 are installed along opposite sidewalls of the truck bed, forming a V-shaped connection with the receptacle 13 suspended between the straps 30 and retaining the cargo to be hauled by the truck. Alternatively, and depicted, a third strap 30 is included that is generally secured to the front wall of the truck bed, thereby staging the third strap 30 approximately and intermediately disposed between the two straps installed along opposite sidewalls. The receptacle 13 includes indicia 20 that provides visual communication to vehicles and/or other traffic that may follow behind the vehicle hauling the cargo retained by the receptacle 13.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A cargo retention system comprising:
a receptacle having an interior and an exterior, the exterior of the receptacle having indicia adapted to visually indicate the terminus of the cargo retained therein;
a plurality of cam-controlled straps, each one of the plurality of cam-controlled straps separately coupled to the exterior of the receptacle, wherein each one of the plurality of cam-controlled straps comprises an elongated strap adjustable and adapted for a variety of lengths via a cam buckle, wherein each one of the plurality of cam-controlled straps is adapted to secure within the bed of a vehicle.

2. A cargo retention system comprising:
a receptacle having an interior and an exterior, the interior of the receptacle adapted to partially retain cargo, the exterior of the receptacle having indicia adapted to visually indicate the terminus of the cargo retained therein;
a plurality of cam-controlled straps, each one of the plurality of cam-controlled straps separately coupled to the exterior of the receptacle, wherein each one of the plurality of cam-controlled straps comprises an elongated strap adjustable and adapted for a variety of lengths via a cam buckle, wherein each one of the plurality of cam-controlled straps is adapted to secure within the bed of a vehicle.

3. The system of claim 2, wherein the interior of the receptacle is formed from a single material selected from the group consisting of rigid material, semi-rigid material, returnably resilient material, flexible material, and fluid permeable material.

4. The system of claim 3, wherein the interior receptacle comprises an adjustable form or shape.

5. The system of claim 3, wherein the interior receptacle comprises a form selected from the group consisting of cylindrical and orthogonal.

6. The system of claim 2, wherein the interior of the receptacle is formed from a combination of materials selected from the group consisting of rigid material, semi-rigid material, returnably resilient material, flexible material, and fluid permeable material.

7. The system of claim 6, wherein the interior receptacle comprises an adjustable form or shape.

8. The system of claim 6, wherein the interior receptacle comprises a form selected from the group consisting of cylindrical and orthogonal.

9. The system of claim 2, wherein the indicia comprises in combination one or more colors, signs, designs, indicators, and alphanumeric symbols.

10. The system of claim 2, wherein the indicia comprises in combination one or more tape, fabric, material, paint, coating, and colorant.

11. A cargo retention system comprising:
a receptacle having an interior and an exterior, the interior of the receptacle adapted to partially retain cargo, the exterior of the receptacle having indicia adapted to visually indicate the terminus of the cargo retained therein;
a plurality of cam-controlled straps, each one of the plurality of cam-controlled straps separately coupled to the exterior of the receptacle, wherein each one of the plurality of cam-controlled straps comprises an elongated strap adjustable and adapted for a variety of lengths via a cam buckle, wherein each one of the plurality of cam-controlled straps is adapted to secure to a hasp affixed within the bed well of a vehicle.

12. The system of claim 11, wherein the interior of the receptacle is formed from a single material selected from the group consisting of rigid material, semi-rigid material, returnably resilient material, flexible material, and fluid permeable material.

13. The system of claim 12, wherein the interior receptacle comprises an adjustable form or shape.

14. The system of claim 13, wherein the interior receptacle comprises a form selected from the group consisting of cylindrical and orthogonal.

15. The system of claim 11, wherein the interior of the receptacle is formed from a combination of materials selected from the group consisting of rigid material, semi-rigid material, returnably resilient material, flexible material, and fluid permeable material.

16. The system of claim 15, wherein the interior receptacle comprises an adjustable form or shape.

17. The system of claim 16, wherein the interior receptacle comprises a form selected from the group consisting of cylindrical and orthogonal.

18. The system of claim 11, wherein the indicia comprises in combination one or more colors, signs, designs, indicators, and alphanumeric symbols.

19. The system of claim 11, wherein the indicia comprises in combination one or more tape, fabric, material, paint, coating, and colorant.
